(19) United States
(12) Patent Application Publication
(10) Pub. No.: US 2019/0106005 A1
(43) Pub. Date: Apr. 11, 2019

(54) MOTOR VEHICLE COMPRISING AN ELECTRICAL ENERGY STORE AND TWO CHARGING INTERFACES, CHARGING SYSTEM AND METHOD

(71) Applicant: AUDI AG, Ingolstadt (DE)

(72) Inventor: Roman Straber, Gaimersheim (DE)

(73) Assignee: AUDI AG, Ingolstadt (DE)

(21) Appl. No.: 15/562,909

(22) PCT Filed: Mar. 29, 2016
(86) PCT No.: PCT/EP2016/056746

§ 371 Date: Dec. 21, 2017

(30) Foreign Application Priority Data
Mar. 31, 2015 (DE) 102015004 119.3

(51) Int. Cl. B60L 53/12

(52) U.S. Cl. CPC B60L 11/1818; B60L 11/1877; B60L 11/1838

(57) ABSTRACT

A motor vehicle with an electrical energy store, a first vehicle-side charging interface and a second vehicle-side interface. The first and the second charging interfaces are coupled to the electrical energy store and can be respectively coupled for parallel charging of the electrical energy store to a respective vehicle-external charging apparatus. The first charging interface and the second charging interface are provided with a uniform design, so that the first charging interface can be coupled by means of the same coupling principle to the first charging apparatus as is the second charging interface to the second charging device.

The invention relates to a motor vehicle provided with an electrical energy storage, a first driver-side charging interface and a second driver-side interface, wherein the first and the second interfaces are coupled to the electrical energy store and can be respectively coupled to a charging apparatus that is external to the vehicle.

Currently, more and more motor vehicles are driven by an electric motor. In this case, the electrical energy that is required to drive the electromotor is stored in an electrical energy store, for example a battery. Such motor vehicles that are driven by electric motors can be pure electric vehicles, but they can also be hybrid motor vehicles, or fuel cell vehicles. In order to charge the electrical energy store, the electrical energy store is as a rule provided with a charging apparatus, for example a charging station. Such charging apparatuses can be for example publically accessible charging points, so-called electric filling stations or E-stations, which are provided with one or several charging columns. At these electric filling stations, a vehicle owner can charge the battery of his motor vehicle by electrically coupling the vehicle via a charging interface on the side of the vehicle to a charging column, for example by means of a charging cable.

To enable quick charging of the battery, such charging system are now often designed as so called rapid-charging facilities in which the charging outputs of about 120 kW or about 150 kW are reached. However, even with these charging capacities of the electrical charging devices, the charging still takes a very long time depending on the capacity of the battery.

In order to further reduce the charging time period, charging outputs of more than 200 kW would be in fact required. At the same time, other problems arise, such as for example the design of the charging cable, which is difficult to be handled by the vehicle owner due to its weight and its rigidity already at facilities using 120 kW.

Other quick charging measures are also known from prior art. In the document WO 2013/023694 A1 is for example disclosed a method for operating a charging station, wherein the electric vehicle is provided with a maximum value for the charging current or for the charging output that is predetermined by the charging station.

The document 2011 003 543 A1 indicates a charging system for charging an electrical energy store of a motor vehicle with a charging interface connected with a cable and with an inductive charging interface. A charging arrangement for a motor vehicle is also known from DE 10 2009 020 504 A1, which is equipped with two energy storage devices for charging the energy storage device of the motor vehicle. The first energy receiving means is in this case designed as a plug connector part and the second energy receiving part enables charging of the energy storage device via a galvanic separation. However, these measures indicated in prior art require a complex charging superstructure because two different charging interfaces are required both on the side of the charging stations and also on the side of the motor vehicle, since two different charging interfaces and charging devices must be provided.

The objective of the present invention is to provide a solution as to how an electrical energy storage device of a motor vehicle can be charged particularly quickly and in a particularly simple manner.

This objective is achieved according to the invention by a motor vehicle and by a charging system as well as by a method that has the features according to the independent patent claims. Preferred embodiments of the invention are the subject of the dependent claims, the description and the figures.

A motor vehicle according to the invention comprises an energy storage device, a first vehicle-side charging interface and a second vehicle-side charging interface, wherein the first and the second charging interfaces are coupled to the electrical energy storage device and can be coupled for parallel charging of the electrical energy storage device to at least one vehicle-external charging device. In addition, the first charging interface and the second charging interface are designed in a uniform manner so that the first charging interface can be coupled by means of the same coupling principle to a first charging apparatus, and the second charging interface is coupled in the same manner to a second charging apparatus.

The motor vehicle is in particular designed as an electric vehicle or a hybrid vehicle. The electrical storage device may be a so called traction battery, for example a 400 V battery, which stores energy that is required to drive the motor vehicle. In order to charge the electric energy storage device, the energy can be transferred to the electrical storage device. This energy can be provided by vehicle-external charging apparatuses, for example charging stations. In order to transfer the energy to the electrical energy storage device, each of the charging interfaces can be coupled to vehicle-external charging apparatuses.

In this case it is provided according to the invention that the first and the second charging interfaces are designed with a uniform construction to the extent that the first charging interface can be also coupled to the charging apparatus and the second charging interface can be also coupled to the first charging apparatus. In other words, under a uniform construction should be understood the fact that the electrical energy storage apparatus is charged via the two charging interfaces in a coupled state of the charging interfaces, in which they are coupled to the charging apparatus, and in which they are charged in both cases with the same charging procedure.

At the same time, energy can be supplied from the first charging apparatus via the first charging interface and from the second charging apparatus via the second charging interface, wherein the energy is transmitted between the respective charging device and the charging interface that is coupled to it in the same manner, which is to say by means of the same energy transmission principle. The electrical energy storage device can be also charged in parallel. With two charging interfaces, the charging output can be doubled to approximately 240 kW, or to 300 kW.

However, it is also possible that more than two uniform interfaces which have a uniform construction are provided, wherein each of the charging interfaces can be coupled to a respective charging apparatus for parallel charging. The charging output can therefore be multiplied.

Such a possibility for quick charging can be provided in a particularly simple manner. This means that there is no need to perform complex modifications of the charging infrastructure in the motor vehicle, since instead, only two uniform charging interfaces are provided on the side of the motor vehicle. At the same time, the existing charging infrastructure of the first charging interface can be used in the motor vehicle also for the second charging interface.

It is particularly preferred when the first and the second charging interfaces are designed as charging sockets for transmitting a direct current that is provided by the respective charging apparatus to the electrical energy storage device. This means that the electrical energy storage device is charged through each interface by means of a so-called direct current charging method. For charging the electrical energy storage device in parallel, both charging apparatuses are inserted, for example in the charging columns. For this purpose, the charging interfaces can be electrically coupled for example via a charging cable with a corresponding plug connector to the respective charging apparatus. This is particularly advantageous because several charging columns are generally available at the electrical current filling stations or E-filling stations, which means that when several uniform charging interfaces are provided for charging at the motor vehicle, several charging columns can be used for charging at the same time.

According to an embodiment, the first charging interface is arranged at a first side of the car body of the motor vehicle and the second charging interface is arranged at the second side of the car body of the motor vehicle, which is opposite the first side, which is in particular equipped with charging sockets and which can be reached particularly easily so that the sockets can be used from two charging columns.

In a further development of the invention, the motor vehicle is provided with an energy distribution interface that is electrically connected for a parallel connection of both charging interfaces and for transmission of the energy that is provided via the charging interfaces to the electrical energy storage device. By means of the energy distribution interface, for example already during the charging with direct current already mentioned above when the motor vehicle is supplied with current from charging columns and via the respective charging interfaces, the system is connected in parallel and the total direct current or total DC current is supplied for charging the electrical energy distribution device. For this purpose, the energy distribution interface is connected for example via electrical feed lines to the respective charging interfaces by means of which the current is transmitted to the energy distribution interface, and to another electrical feed line by means of which it is connected to the electrical energy store so that the current is forwarded to the electrical energy store.

The energy distribution interface can in this case be a current node, wherein the currents that are provided by the charging apparatuses to flow to the current nodes and the total current flows away from the current nodes in the direction of the electrical energy store. However, the energy distribution interface can be also a battery electric box, or a battery junction box (BJB), in which the electrical feed lines connected to the charging interfaces and to the energy store are combined. The charging energy can be supplied by means of the energy distribution interface in a particularly simple way to the electrical store, without for example having to provide additional connections to the electrical energy store.

It is preferred when the motor vehicle is equipped with a communication device for communicating with the charging apparatus and with the energy distribution interface. The communication interface is designed to coordinate a charging operation and to set for the charging device for example a predetermined value for the charging current. This makes it possible to ensure particularly reliable charging of the energy store.

According to an advantageous embodiment of the invention, the electrical energy store is provided with a first partial energy storage device which is electrically coupled for charging the first partial energy storage device to the first charging interface, and the electrical energy store is also provided with a second partial energy storage device which is coupled for charging the second partial device to the second charging interface. Both partial energy storage device can be provided in the motor vehicle so that they are galvanically separated from each other and thus form a part of a so-called multi-machine concept. So for example, the first partial energy storage device can be used for driving the front axle of the motor vehicle and the second partial energy storage device can be used for driving the rear axle of the motor vehicle. Both of these partial energy storage device can be charged separately from each other, wherein the first partial energy storage device is supplied via the first charging interface from the first charging apparatus and the second partial energy storage device is supplied via the second charging interface from the second charging apparatus. At the same time, the two partial energy storage devices can be charged in parallel and this can be done in a particularly short time period.

It is particularly advantageous when the motor vehicle is provided with a switching device by means of which the two partial energy storage devices can be connected and/or separated. With a closed switching device, the partial energy storage devices can be connected in parallel or in series. When the switching device is opened, the electrical energy store can be divided into two partial electrical energy storage devices. Both partial energy storage device can be designed for example as low-voltage batteries. By closing the electrical energy store, both low-voltage batteries can be connected in series, so that the electrical energy store can be designed as a high-voltage battery. Under a high-voltage battery is here to be understand for example a battery providing a voltage between 700 V and 900 V, in particular 800 V. Under a low-voltage battery is here to be understood for example a battery providing a voltage between 350 V and 450 V, in particular 400 V.

It is preferred when the motor vehicle is equipped with a control device that is designed to open the two partial energy storage devices during the charging for a galvanic separation, and after the end of the charging to close the two partial energy storage device for an electrical connection. In other words, both partial energy storage devices are separated from each other during the charging operation, so that they can be charged in parallel in a particularly simple manner. With the separation of the partial energy charging devices, it is advantageously not necessary to pay attention to each respective charging state of the partial energy storage devices, for example to potential compensating currents between the particular energy storage devices.

The separation of both partial energy storage devices is also particularly advantageous when the electrical energy store is designed as a high-voltage battery that is provided with a series circuit of the low-voltage batteries. This is because a special charging equipment is usually required for charging a high-voltage battery. By dividing the high-voltage battery into two low-voltage batteries, a conventional charging column can be also used for charging because each low-voltage battery can be charged separately via one charging interface and one charging device.

It should be noted that the motor vehicle can be also provided with more than just two partial energy storage devices when a separate, uniform charging interface is provided for each partial energy storage device.

The invention also relates to a charging system with a motor vehicle and two vehicle-external charging apparatuses, wherein a first of the vehicle-external charging apparatuses is coupled to the first charging interface and a second of the vehicle-external charging devices is coupled to the second charging interface for parallel charging of the electrical energy charging store. The charging apparatuses can be provided as charging columns of a current filling station. In this case, the charging apparatuses can provide for example direct current, which are for example connected via a charging cable for supplying the motor vehicle via a respective interface through a plug connector.

However, it can be also provided that the charging apparatuses are common household electrical sockets that are connected to an alternating current network and provide an alternating current. This alternating current can be supplied to the motor vehicle via the charging interfaces and it can be rectified by means of a vehicle-internal rectifier for charging the electrical energy store. The charging operation is thus in this case charging with alternating current.

As an alternative, the charging apparatuses can be designed as primary coils and the charging interfaces can be designed as secondary coils, wherein the energy is transferred from the charging apparatuses to the charging interfaces inductively. The charging process is thus in this case inductive charging.

The invention relates in addition to a method for parallel charging of an electrical energy store of a motor vehicle with a first vehicle-side interface and a second vehicle-side charging interface, wherein the electrical energy store is charged via the charging interface by means of the same charging method.

The preferred embodiment mentioned with reference to the motor vehicle according to the invention and their advantages are applied according to the charging system according to the invention as well as to the method according to the invention.

The invention will now be explained in the following based on an embodiment and with reference to the accompanying drawings.

The drawings show the following:

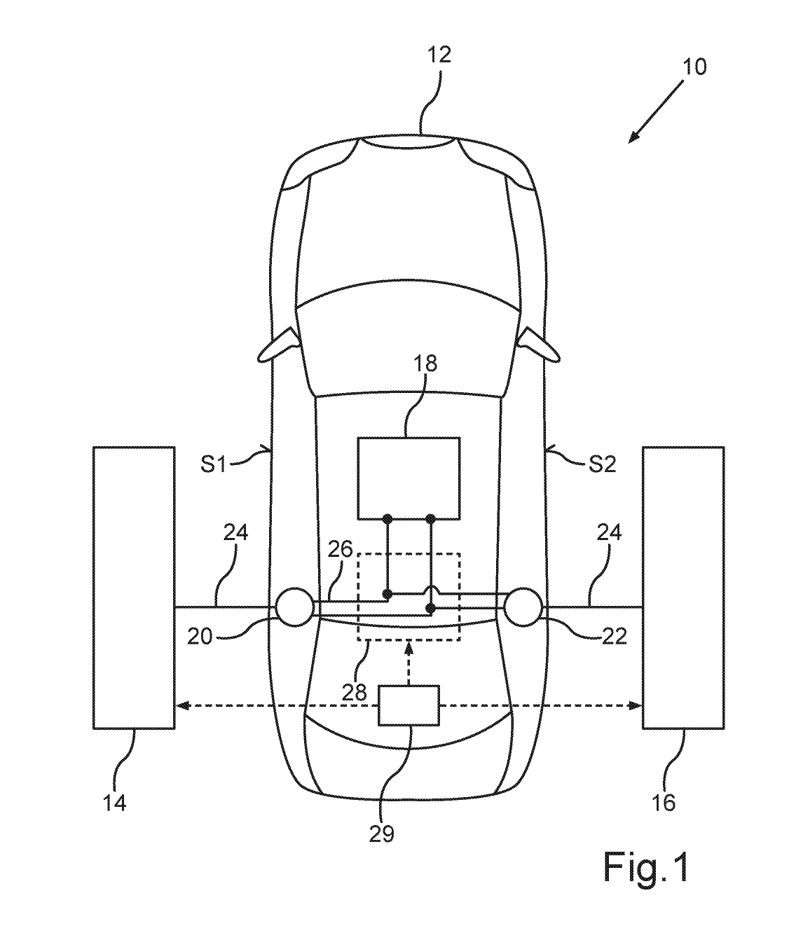

FIG. 1 a schematic representation of an embodiment of a motor vehicle including a charging system according to the invention;

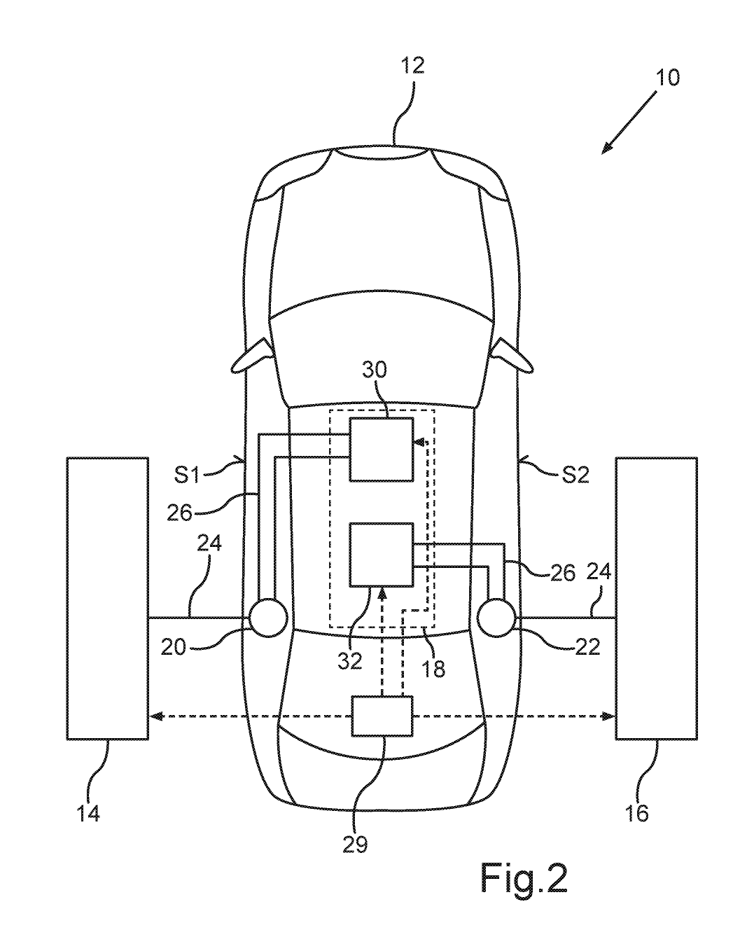

FIG. 2 a schematic representation of another embodiment of a motor vehicle including a charging system according to the invention;

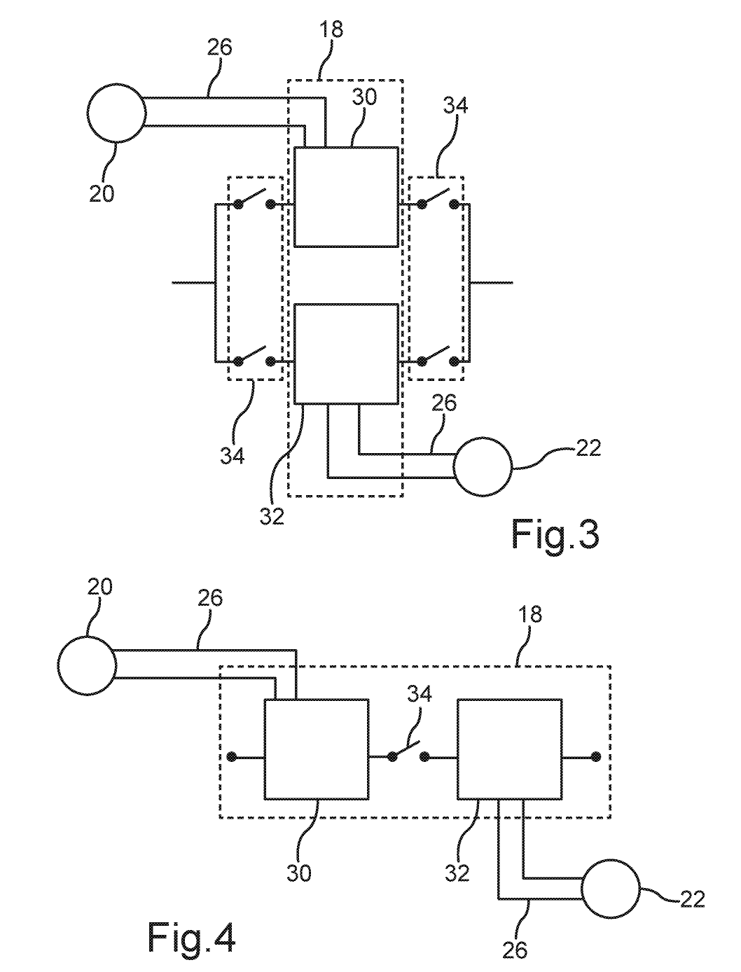

FIG. 3. a schematic representation of an embodiment of an electrical energy store; and

FIG. 4 a schematic representation of another representation of an electrical energy store.

The embodiment described below is a preferred embodiment of the invention. The components described in the embodiment represent individual features of the invention which are independent of each other, wherein each of them is to be regarded also individually, or they can be regarded as components of the invention in other combinations than those indicated. In addition, the described embodiment can be also complemented by other features of the invention that were already described.

FIG. 1 shows a charging system 10 with a motor vehicle 12, a first charging apparatus 14 and a second charging apparatus 16. The motor vehicle 12 is in the present case designed as an electric motor vehicle, or as a hybrid vehicle, or as a fuel cell vehicle which is driven by an electric motor. The electrical energy required for driving the electric motor is stored in an electrical energy store 18 of the motor vehicle 12, for example in a so-called traction battery. The traction battery can be designed for example as a 400 V battery.

The energy is provided for a parallel charging of the electrical energy store 18 of the motor vehicle 12 by the charging apparatuses 14, 16. The charging apparatuses 14, 16 can be designed for example as charging column of an electric current filling station which provide the energy in the form of a direct electric current. In order to supply the energy from the charging apparatuses 14, 16, in particular simultaneously, to the electrical energy store 18 for charging, the motor vehicle 12 is provided with two uniform charging interfaces 20, 22. The charging interfaces 20, 22 can be in this case arranged at the motor vehicle 12 in any manner. It is preferred when a first charging interface 20 is arranged on a first side S1 of the motor vehicle 12 and a second charging interface 22 is arranged on a second side S2 of the motor vehicle 12, opposite the first side S1.

The uniform charging interfaces 20, 22 of the motor vehicle 12 are electrically connected within the charging system 10 via a charging cable 24 to the respective charging apparatuses 14, 16. The charging interfaces 20, 22 are in this respect designed with the same construction so that the first charging interface 20 can be also coupled to the second charging device 16, and the second charging interface 22 can be also coupled to the first charging apparatus 14. In other words, this means that the first charging apparatus 14 transmits energy by means of the same transmission principle at the first charging interface 20 that the second charging apparatus is using for transmitting energy at the second charging interface 22.

The charging interfaces 20, 22 are electrically connected to the electrically energy store 18. For this purpose, the charging interface 20, 22 are electrically connected via electrical feed lines to an energy distribution interface 28. By means of the energy distribution interface 28, which can be designed for example as a so-called battery electric box, the charging interfaces 20, 22 are connected in parallel so that the direct current supplied to the electrical store is obtained from the sum of the respective electrical direct currents, which are transmitted from the respective charging apparatuses 14, 16 via the charging cable 24 to the respective charging interfaces 20, 22. A communication device 29 of the motor vehicle 12 can communicate with the energy distribution interface 28 and with the charging apparatuses 14, 16 and coordinate and control in this manner the parallel charging process of the electrical energy store 18.

Direct current charging was thus described in the present case. However, it can be also provided that an alternating current charging or an inductive current charging is realized by means of the charging system 10 according to the invention. Witch alternative current charging, a charging current is supplied to both charging interfaces 20, 22 from the respective charging apparatuses 14, 15, which is rectified by a rectifier on the side of the vehicle and supplied to the energy store as a direct current. The charging apparatuses 14, 16 can in this case be provided as common household electrical outlets connected to an alternating current network. However, it can be also provided that the respective charging apparatuses 14, 16 are provided as primary coils and the charging interfaces 20, 22 are provided as secondary coils. In this case, the inductive energy is transmitted from the charging interface 14 to the charging interface 20, as well as inductively from the charging apparatus 16 to the charging interface 22.

The core of the invention is therefore that the electrical store 18 can be charged simultaneously via a plurality of charging apparatuses 14, 16, while the same energy transmission principle is used during the transmission of energy. In other words, the electrical energy store 18 is charged for example through all the charging interfaces 20, 22 for example only inductively, or only charged inductively with direct current, or only with alternating current.

So for example, it can be provided that for instance a charging voltage of 50 kW is transmitted via the first charging interface 20 and a for example a charging voltage of 150 kW is transmitted via the second charging interface, wherein the charging interfaces 20, 22 are designed with the same construction to the extent that for example only direct current is transmitted via both charging interfaces 20, 22.

FIG. 2 shows another embodiment of a motor vehicle 12 within the context of the charging system 10. According to this embodiment, the electrical energy store 18 is equipped with two partial energy storage devices 30, 32. The first partial energy storage device 30 can be used for example for driving a front axle of the motor vehicle 12. The second partial energy storage device 32 can be used for driving a rear axle of the motor vehicle 12. The partial energy storage devices 30, 32 can be designed for example as 400 V batteries. It is then provided that the first partial energy storage device 30 is electrically connected via electrical feed lines 26 to the first charging interface 20. The first partial energy storage device 30 is therefore supplied from the charging apparatus 14 via the first charging interface 20 and thus also charged with electrical energy. The second partial energy storage device 32 is electrically connected via the feed lines 26 to the second charging interface 22. The second partial energy storage device 32 is therefore supplied with electrical energy from the second charging apparatus 16 via the charging interface 22 for charging the second partial energy store 32.

In order to coordinate the charging process, the communication device 29 of the motor vehicle 12 communicates with the charging apparatuses 14, 16 as well as with the electrical partial energy storage devices 30, 32. The communication device 29 can be a central communication device. However, it can be also provided that a separate communication device 29 is used for each of the partial communication storage devices 30, 32, wherein the respective communication device 29 can communicate with the charging apparatuses 14, 16 that are connected to the respective partial energy storage devices 30, 32.

FIG. 3 shows an embodiment of the electrical energy store 18 of the motor vehicle 12 with the two partial energy storage device 30, 32. The partial energy storage devices 30, 32 can be in this case electrically connected via switching devices 34 and they can be electrically separated from each other. During the charging operation, the switching devices 34 are opened so that the partial energy storage devices 30, 32 are galvanically separated from each other. The partial energy storage devices 30, 32 are therefore galvanically separated from each other and charged via the respective charging interfaces 20, 22. In an operation of the motor vehicle 12, which is to say after the end of the charging process, the switching devices 34 can be closed for parallel switching of the electrical partial energy storage devices 30, 32. For this purpose, a control device, not shown here, can exercise control so as to open and close the switching devices 34.

FIG. 4 shows another embodiment of the electrical energy store 18 that is provided with two partial energy storage device 30, 32. The partial energy stores 30. 32 can be electrically connected via the switching device 34 to a series switch 34 for a connection in series. While the partial energy devices were so far designed as 400 V batteries, with the series switch, which is to say when the series switch 34 is closed, an 800 V energy store 18 is produced. The electrical energy store 18 is thus designed as a so-called high-voltage energy store. During the charging process, the switching device 34 is opened so that the partial energy storage devices 30, 32 are charged while they are separated from each other via the charging interfaces 20, 22. By separating the two partial energy storage devices 30, 32, which is to say by dividing the high-voltage energy storage device into two low-voltage energy storage devices, conventional charging devices 14, 16 can be used for charging the respective partial energy storage devices 30, 32. Special charging devices required for the charging of high-voltage batteries can be therefore avoided in an advantageous manner. In other words, the already existing charging interface can be used in order to provide at the same time a high-voltage battery as well as to use conventional charging devices for charging the high-voltage battery.

1-10. (canceled)

11. A motor vehicle comprising:
an electrical energy store, a first vehicle-side charging interface and a second vehicle-side charging interface, wherein the first and the second charging interface are coupled and can be coupled for parallel charging of the electrical energy store to the respective vehicle-external charging apparatus, wherein the first charging interface and the second charging interface are provided with a uniform design, so that the first charging interface can be coupled by the same coupling principle to the first charging apparatus, in the same manner as the second charging interface is coupled to the second charging apparatus.

12. The motor vehicle according to claim 11, wherein the first and the second charging interface are designed as charging sockets for transmitting a direct current provided by the respective charging apparatuses to the electrical energy store.

13. The motor vehicle according to claim 11, wherein the first charging interface is arranged on a first side of the car body of the motor vehicle, and the second charging interface is arranged at a second side opposite the first side of the car body of the motor vehicle.

14. The motor vehicle according to claim 11, wherein the motor vehicle is provided with an energy distribution interface, which is electrically connected for connecting in parallel both charging interfaces to both charging interfaces, and for transmitting via the charging interfaces energy provided by the charging devices which are electrically connected to the electrical energy store.

15. The motor vehicle according to claim 14, wherein the motor vehicle is provided with a communication device for communicating with the charging device and with the energy distribution interface.

16. The motor vehicle according to claim 11, wherein the electrical energy store is provided with a first partial energy storage device, which is electrically coupled for charging the first partial energy storage device to the first charging interface, and the electrical energy store is provided with a second partial energy storage device, which is electrically coupled for charging the second partial energy storage device to the second charging interface.

17. The motor vehicle according to the claim 16, wherein the motor vehicle is provided with a switching device by which the two partial energy storage devices can be electrically connected and galvanically separated.

18. The motor vehicle according to claim 17, wherein the motor vehicle is provided with a control device, which is designed to be opened during the charging process for galvanic separation of the two partial energy storage devices, and to be closed after the end of the charging process for an electrical connection of the two partial energy storage devices.

19. A charging system with a motor vehicle and two vehicle-external charging devices, wherein a first of the vehicle-external charging devices is coupled to the first charging interface, and a second of the vehicle-external charging devices is coupled to the second charging interface for a parallel charging of the electrical energy store.

20. A method for parallel charging of an electrical energy store of a motor vehicle with a first vehicle-side charging interface and with a second vehicle-side charging interface, wherein the electrical energy store is charged via the charging interfaces by the same charging method.
